(19) United States
(12) Patent Application Publication
(10) Pub. No.: US 2012/0052209 A1
(43) Pub. Date: Mar. 1, 2012

(54) Composition for Paper Coating

(75) Inventors: MinHo Jeon, Daejeon (KR); JiEun Yoo, Daejeon (KR); MoonJung Choi, Seoul (KR); MyungAhn Ok, Daejeon (KR); KwangJin Chung, Daejeon (KR)

(73) Assignee: SK INNOVATION CO., LTD., Seoul (KR)

(21) Appl. No.: 13/218,163

(22) Filed: Aug. 25, 2011

(30) Foreign Application Priority Data
Sep. 1, 2010 (KR) 10-2010-0085514
Aug. 24, 2011 (KR) 10-2011-0084340

(51) Int. Cl. B05D 3/12; C09D 169/00

(52) U.S. Cl. 427/358; 524/612; 524/539; 427/427.6

(57) ABSTRACT

Provided is a composition for paper coating, including aliphatic polycarbonate having an average molecular weight of 50000˜3000000 obtained by reaction of one or at least two different kinds of epoxide compounds selected from the group consisting of (C2-C10)alkylene oxide substituted or unsubstituted with carbon dioxide, halogen, or alkoxy; (C4-C20)cycloalkylene oxide substituted or unsubstituted with halogen or alkoxy; and (C8-C20)styrene oxide substituted or unsubstituted with halogen, alkoxy, alkyl or aryl. Also, provided is a method for coating a paper, by extrusion-coating the composition for paper coating at 150 to 230° C. on the paper to manufacture a coated paper.

### TECHNICAL FIELD

The present invention relates to a composition for paper coating.

### BACKGROUND ART

Development of scientific techniques and improvement and convenience in the standard of living has resulted in a rapid increase in use of disposable products. Especially, a paper coated with polymer such as polyethylene (PE) has been used in various ranges of disposable container fields. A general polyethylene-coated paper is manufactured by extrusion-coating polyethylene on one surface or both surfaces of a paper. For this reason, it commonly refers to a paper which functions to prevent outflow of contents and absorption of moisture.

This polyethylene-coated paper blocks moisture due to the excellent moisture barrier property thereof. However, a container made of the polyethylene-coated paper causes contents to be oxidized and become rotted since the polyethylene-coated paper has an inferior oxygen barrier property. Therefore, in order to prevent food from being oxidized and become rotted due to contact with oxygen and allow a long-period of preservation, an aluminum-coated layer such as Tetra Pack is introduced to the paper to enhance the oxygen barrier property or Nylon or EVOH is coated on the paper. However, the introduction of aluminum-coated layer has economic disadvantages in that aluminum is a high-priced material and the process cost is high. The use of Nylon and EVOH also has economic disadvantages in that they are expensive and an additive bonding layer is required.

Further, polyethylene, which is a representative non-polar resin, has inferiority in printability, which is importantly required as a material for packaging, and also has inferiority in adhesion with paper due to nonpolarity thereof. Therefore, when polyethylene is coated, it is thermally oxidized by extrusion at a high temperature of 300 to 350° C., which induces a polar group on a melted surface, thereby improving the adhesion with paper.

Further, the polyethylene-coated paper needs to be subjected to a disintegrating procedure of paper and polyethylene using chemicals at the time of a recycling procedure. For this reason, the recycling procedure is complicated, which leads to a low recycling ratio, and thus, most of the polyethylene-coated paper is incinerated.

Accordingly, a coated paper having an excellent oxygen barrier property and good printability, and being reusable by easily removing a coating material and collecting paper is required in terms of economic and environmental reasons.

### DISCLOSURE

### Technical Problem

An object of the present invention is to provide an eco-friendly composition for paper coating, which has an excellent oxygen barrier property and printability, and allows paper to be easily recycled by using a thermal decomposition temperature lower than that of a paper.

### Technical Solution

In one general aspect, a composition for paper coating according to the present invention includes aliphatic polycarbonate having an average molecular weight of 50000˜3000000 obtained by reaction of one or at least two different kinds of epoxide compounds selected from the group consisting of (C2-C10)alkylene oxide substituted or unsubstituted with carbon dioxide, halogen, or alkoxy; (C4-C20)cycloalkylene oxide substituted or unsubstituted with halogen or alkoxy; and (C8-C20)styrene oxide substituted or unsubstituted with halogen, alkoxy, alkyl or aryl.

The aliphatic polycarbonate may be expressed by Chemical formula 1 below.

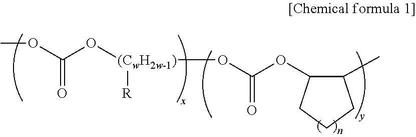

[Where, in the Chemical formula 1, w is an integer of 2 to 10, x is an integer of 5 to 100, y is an integer of 0 to 100, n is an integer of 1 to 3, and R is hydrogen, (C1-C4) alkyl or —CH2-O—R′(R′ is (C1˜C8)alkyl).

The composition for paper coating may contain 1 to 70 wt % of polylactic acid based on the total amount of the coating composition. When the polylactic acid is contained in a content of the above range, a coated paper has improved heat resistance. If the content of the polylactic acid is more than 70 wt % based the total amount of the coating composition, a Neck-in phenomenon becomes severe, resulting in poor coating property, and thus, the coating composition after coating is easy to break and oxygen barrier property can not be realized.

In another aspect, a method for coating a paper according to the present invention is characterized in that the composition for paper coating is extrusion-coated on the paper at 150 to 230° C., and more preferably 150 to 200° C., to manufacture a coated paper. If coating is performed at a temperature higher than the above range, coating characteristics are rapidly deteriorated and the aliphatic polycarbonate becomes severely deformed. If coating is performed at a temperature lower than the above range, a uniform melt curtain is not formed at the time of coating, which causes a large deviation in coating thickness.

As a coating extruder, it is preferable to use a single-screw extruder capable of providing a short retention time and a uniform distribution with respect to the coating composition rather than a twin-screw extruder capable of providing stable delivery, a long retention time, and a wide distribution with respect to the coating composition.

The manufactured coated paper may contain a residual coating composition in a content of 2 wt % or less based on the total amount of the coating composition before thermal treatment, when the thermal treatment is performed at 220° C. for 60 minutes under the inert gas ambience. More specifically, as for the coated paper manufactured by the method for coating a paper according to the present invention, the coating composition is almost decomposed without leaving residues, and thus only paper can be easily collected, when the thermal treatment is performed at a temperature range of 220° C. to 250° C. for 60 minutes under the nitrogen or oxygen ambience.

### Advantageous Effects

The coated paper manufactured according to the present invention can prevent food from being easily rotted when it is used for a food container due to excellent oxygen barrier property thereof, and can be easily recycled due to a low thermal decomposition temperature. In addition, the composition for paper coating according to the present invention can facilitate coating due to excellent printability and adhesion thereof. In addition, the coating composition is decomposed without leaving residues and thus only paper can be easily collected, at the time of thermal treatment at a low temperature.

### DESCRIPTION OF DRAWINGS

FIG. 1 shows a coated paper according to the present invention.

### BEST MODE

Hereinafter, the present invention will be understood and appreciated more fully from the following examples, and the examples are for illustrating the present invention and not for limiting the present invention.

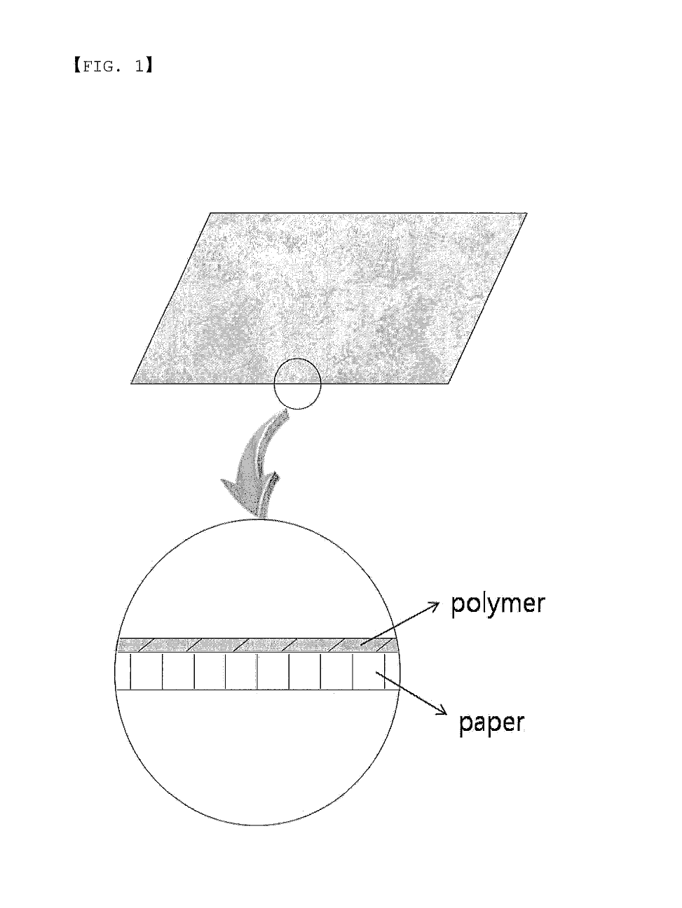

FIG. 1 shows a coated paper according to the present invention, and a polymer means aliphatic polycarbonate according to the present invention.

### Preparing Example 1

### Synthesis of Complex Compound 1

Complex compound 1 was synthesized according to Chemical formula 2. Compound A was synthesized according to a known method (Bull. Korean Chem. Soc. 2009, 30, 745-748).

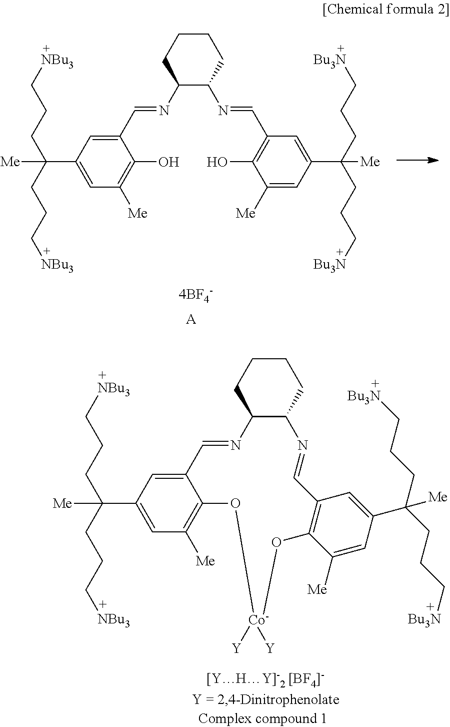

Compound A (0.376 g, 0.230 mmol) and Co(OAc) (0.041 g, 0.230 mmol) were quantitated and put into a 50 mL of round flask within a glove box, and ethanol (17 mL) was added thereto, followed by stirring for 3 hours. 20 mL of diethylether was added thereto, thereby generating precipitation. The resulting material was filtered by using a glass filter and then washed with 10 mL of diethylether three times. An orange solid thus obtained was subjected to reduced pressure, thereby completely removing a solvent. A Co (II) compound (0.200 g, 0.117 mmol) thus obtained was dissolved by input of 2,4-Dinitrophenol (0.022 g, 0.117 mmol) thereinto and addition of methylene chloride (5 mL) thereto. Then, the resulting material was stirred for 3 hours under the oxygen ambience, and thus oxidized. 60 mol % of sodium dinitrophenolate (0.121 g, 0.585 mmol) was added thereto, followed by stirring for 12 hours. The resulting material was filtered by using a glass filter, thereby removing solid therefrom. A methylene chloride solution thus obtained was subjected to reduced pressure to remove a solvent, thereby obtaining a reddish-brown sold (0.284 g, 0.111 mmol). Yield 95%, ¹HNMR (dmso-d₆,40° C.): δ8.62 (br, 3H, (NO₂)₂C₆H₃O), 8.03 (br, 3H, (NO₂)₂C₆H₃O), 7.87 (br, 1H, CH═N), 7.41-7.22 (br, 2H, m-H), 6.71 (br, 3H, (NO₂)₂C₆H₃O), 3.62 (br, 1H, cyclohexyl-CH), 3.08 (br, 16H, NCH₂), 2.62 (s, 3H, CH₃), 2.09 (1H, cyclohexyl-CH), 1.89 (1H, cyclohexyl-CH), 1.72-1.09 (br, 37H), 0.87 (br, 18H, CH3) ppm.

### Preparing Example 2

### Synthesis of Complex Compound 2

Complex compound 2 was synthesized by Chemical formula 3. Compound B was synthesized according to a known method (Bull. Korean Chem. Soc. 2009, 30, 745-748).

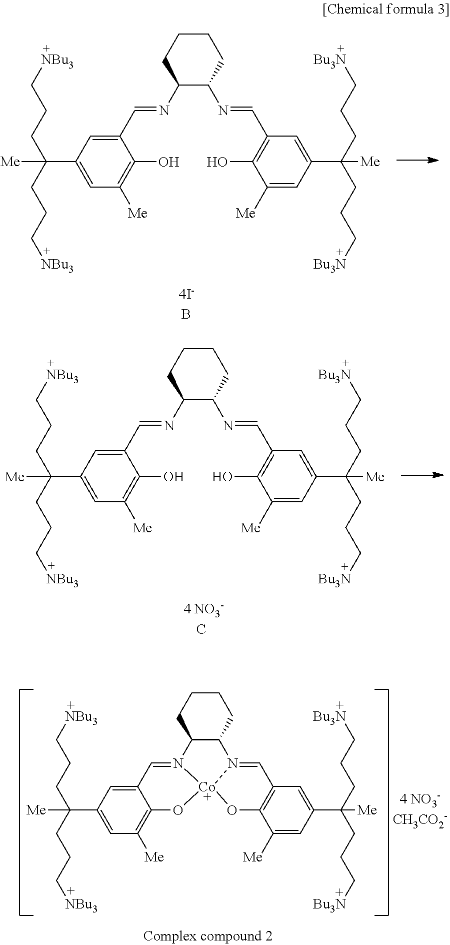

Synthesis of Compound C

Compound B (100 mg, 0.054 mmol) and AgNO₃ (37.3 mg, 0.219 mmol) were dissolved in ethanol (3 mL), followed by stirring overnight. The resulting mixture was filtered by using cellite, thereby removing AgI generated. The resulting material was subjected to reduced pressure to remove a solvent, thereby obtaining yellow solid powder type compound C (0.80 g, 94%).

¹H NMR (CDCl₃): δ13.51 (s, 2H, OH) 8.48 (s, 2H, CH═N), 7.15 (s, 4H, m-H), 3.44 (br, 2H, cyclohexyl-CH), 3.19 (br, 32H, NCH₂) 2.24 (s, 6H, CH₃), 1.57-1.52 (br, 4H, cyclohexyl-CH₂) 1.43-1.26 (br, 74H), 0.90-0.70 (br, 36H, CH₃) ppm.

Synthesis of Complex Compound 2

Compound C (95 mg, 0.061 mmol) and Co(OAc)₂ (10.7 mg, O. 061 mmol) were put into a flask, and dissolved by addition of 3 mL of methylene chloride thereto. The resulting material was stirred at room temperature for 3 hours under oxygen gas, and subjected to reduced pressure to remove a solvent, thereby obtaining brown solid powder type complex compound 2 (85 mg, 83%).

¹H NMR (DMSO-d₆, 38° C.): major signal set, δ7.83 (s, 2H, CH═N) 7.27 (br s, 2H, m-H), 7.22, 7.19 (br s, 2H, m-H), 3.88 (br, 1H, cyclohexyl-CH), 3.55 (br, 1H, cyclohexyl-CH), 3.30-2.90 (br, 32H, NCH₂) 2.58 (s, 3H, CH₃), 2.55 (s, 3H, CH₃), 2.10-1.80 (br, 4H, cyclohexyl-CH₂) 1.70-1.15 (br m, 74H), 1.0-0.80 (br, 36H, CH₃) ppm; minor signal set, 57.65 (s, 2H, CH═N) 7.45 (s, 2H, m-H), 7.35 (s, 2H, m-H) 3.60 (br, 2H, cyclohexyl-CH), 3.30-2.90 (br, 32H, NCH₂) 2.66 (s, 6H, CH₃) 2.10-1.80 (br, 4H, cyclohexyl-CH₂) 1.70-1.15 (br m, 74H) 1.0-0.80 (br, 36H, CH₃) ppm.

¹H NMR (CD₂Cl₂): δ7.65 (br, 2H, CH═N), 7.34 (br, 2H, m-H), 7.16 (br, 2H, m-H), 3.40-2.00 (br, 32H, NCH₂), 2.93 (br s, 6H, CH₃) 2.10-1.80 (br m, 4H, cyclohexyl-CH₂), 1.70-1.15 (br m, 74H), 1.1-0.80 (br, 36H, CH₃) ppm.

### Preparing Example 3

### Synthesis of Copolymer (PPC) Using Carbon Dioxide/Propylene Oxide

Propylene oxide (1162 g, 20.0 mol), in which the complex compound 1 (0.454 g, which is an amount calculated according to a monomer/catalyst ratio) was dissolved, was injected to 3 L of an autoclave reactor through a cannula. The complex compound 1 prepared according to the preparing example 1 was used as the complex compound. Carbon dioxide was input to the reactor at a pressure of 17 bar, and the resulting mixture was stirred within a circulation water bath of a temperature previously set to 70° C. while increasing the temperature of the reactor. After 30 minutes, the time point when a pressure of the carbon dioxide starts to fall was recorded, and reaction is performed for 2 hours from the time point, followed by degassing of carbon dioxide, thereby finishing the reaction. 830 g of propylene oxide was further added into the viscous solution thus obtained, thereby lowering viscosity of the solution. Then the resulting solution was passed through silica gel (50 g, Merc Company, 0.040˜0.063 mm particle size (230˜400 mesh)) pads to obtain a colorless solution. The resulting solution was subjected to reduced pressure to remove monomer, thereby obtaining 283 g of white solid. The polymer thus obtained had a weight average molecular weight (Mw) of 290,000 and a polydispersity index (PDI) of 1.30. The weight average molecular weight and polydispersity index thereof were measured by using GPC.

### Preparing Example 4

### Synthesis of Copolymer (PPC) Using Carbon Dioxide/Propylene Oxide

Propylene oxide (1162 g, 20.0 mol), in which the complex compound 2 (0.224 g, which is an amount calculated according to a monomer/catalyst ratio) was dissolved, was injected to 3 L of an autoclave reactor through a cannula. The complex compound 2 prepared according to the preparing example 2 was used as the complex compound. Carbon dioxide was input to the reactor at a pressure of 17 bar, and the resulting mixture was stirred within a circulation water bath of a temperature previously set to 70° C. while increasing the temperature of the reactor. After 30 minutes, the time point when a pressure of the carbon dioxide starts to fall was recorded, and reaction was performed for 2 hours from the time point, followed by degassing of carbon dioxide, thereby finishing the reaction. 830 g of propylene oxide was further added into the viscous solution thus obtained, thereby lowering viscosity of the solution. Then the resulting solution was passed through silica gel (50 g, Merc Company, 0.040˜0.063 mm particle size (230˜400 mesh) pads, thereby obtaining a colorless solution. The resulting solution is subjected to vacuum reduced pressure to remove monomer, thereby obtaining 348 g of white solid. The polymer thus obtained had a weight average molecular weight (Mw) of 316,000 and a polydispersity index (PDI) of 1.78. The weight average molecular weight and polydispersity index thereof were measured by using GPC.

### Preparing Example 5

### Synthesis of Terpolymer Using Carbon Dioxide/Propylene Oxide/Cyclohexene Oxide

Propylene oxide (622.5 g, 10.72 mol), in which the complex compound 1 (0.406 g, which is an amount calculated according to a monomer/catalyst ratio) was dissolved, and cyclohexene oxide were inj ected to 3 L of an autoclave reactor through a cannula. The complex compound 1 prepared according to the preparing example 1 was used as the complex compound. Carbon dioxide was input to the reactor at a pressure of 17 bar, and the resulting mixture was stirred within a circulation water bath of a temperature previously set to 70° C. while increasing the temperature of the reactor. After 30 minutes, the time point when a pressure of the carbon dioxide starts to fall was recorded, and reaction was performed for 2 hours from the time point, followed by degassing of carbon dioxide, thereby finishing the reaction. 830 g of propylene oxide was further added into the viscous solution thus obtained, thereby lowering viscosity of the solution. Then the resulting solution was passed through silica gel (50 g, Merc Company, 0.040˜0.063 mmparticle size (230˜400 mesh)) pads, thereby obtaining a colorless solution. The resulting solution is subjected to vacuum reduced pressure to remove monomer, thereby obtaining 283 g of white solid.

The polymer thus obtained had a weight average molecular weight (Mw) of 210,000 and a polydispersity index (PDI) of 1.26, and a ratio of the cyclohexene carbonate within the polymer was 25 mol %. The weight average molecular weight and polydispersity index thereof were measured by using GPC, and the ratio of the cyclohexene carbonate within the polymer was calculated by analyzing ¹H NMR spectrum.

### Example 1

The PPC having an average molecular weight of 150000, which was prepared in the preparing example 3, was extruded through a T-die single screw extruder (Brabender Company) and continuously coated on a paper.

An extruding barrel of the extruder consisted of 4 parts, and temperatures thereof were 150° C., 170° C., 200° C., and 200° C., respectively. Temperature of T-die was 200° C.

The manufactured coated paper had a total thickness of 215 μm and a coating thickness of 15 μm.

### Example 2

The manufacturing of a coated paper was performed in the same manner as Example 1, except that temperatures of the 4 parts of the extruding barrel in the extruder were 180° C., 210° C., 220° C., and 230° C., respectively, and temperature of T-die was 230° C.

The manufactured coated paper had a total thickness of 211 μm and a coating thickness of 11 μm.

### Example 3

The manufacturing of a coated paper was performed in the same manner as Example 1, except that PPC and polylactic acid (PLA) mixed at a weight ratio of 7:3 were used instead of PPC, temperatures of the 4 parts of the extruding barrel in the extruder were 150° C., 170° C., 200° C., and 210° C., respectively, and temperature of T-die was 210° C.

The manufactured coated paper had a total thickness of 220 μm and a coating thickness of 20 μm.

### Example 4

The manufacturing of a coated paper was performed in the same manner as Example 1, except that PPC and polylactic acid mixed at a weight ratio of 3:7 were used instead of PPC, temperatures of the 4 parts of the extruding barrel in the extruder were 150° C., 170° C., 200° C., and 210° C., respectively, and temperature of T-die was 210° C.

The manufactured coated paper had a total thickness of 220 μm and a coating thickness of 20 μm.

### Experimental Example 1

The manufactured example 1 was analyzed by using TGA.

As a result, first, residues except paper had a content of 0.5 wt % under air, 240° C., 1 hour, and constant-temperature TGA conditions, and second, residues except paper had a content of 0.8 wt % under N₂, 240° C., 1 hour, and constant-temperature TGA conditions.

### Experimental Example 2

Physical properties of the manufactured examples 1 to 4 were measured and recorded in Table 1.

In Table 1, coating characteristics were evaluated as follows.

<Evaluation on Coating Characteristics>

◯: The coated surface had a good appearance and an uniform coating thickness.

Δ: The coated surface had a good appearance but a variation in coating thickness.

X: The coated surface had a bad appearance and had bubbles and the like.

In Table 1, heat-resistant temperatures were evaluated as follows.

<Evaluation on Heat-Resistant Temperatures>

An upper limit temperature at which delamiation or deformation of a coated surface does not occur during the time from when the manufactured coated paper is put into a circulation to when one hour passes while maintaining a constant temperature was measured.

TABLE 1

| | Unit | Example 1 | Example 2 | Example 3 | Example 4 |
|---|---|---|---|---|---|
| PPC content | wt. % | 100 | 100 | 70 | 30 |
| PLA content | wt. % | 0 | 0 | 30 | 70 |
| Coating | μm | 15 | 11 | 20 | 20 |
| thickness | | | | | |
| Oxygen | cc/ | 121 | 182 | 152 | 726 |
| permeability | m²day | | | | |
| Coating | — | ◯ | X | Δ | Δ |
| characteristics | | | | | |
| Heat-resistant | ° C. | 85 | 85 | 95 | — |
| temperature | | | | | |

1. A composition for paper coating, comprising aliphatic polycarbonate having an average molecular weight of 50000˜3000000 obtained by reaction of one or at least two different kinds of epoxide compounds selected from the group consisting of (C2-C10)alkylene oxide substituted or unsubstituted with carbon dioxide, halogen, or alkoxy; (C4-C20) cycloalkylene oxide substituted or unsubstituted with halogen or alkoxy; and (C8-C20)styrene oxide substituted or unsubstituted with halogen, alkoxy, alkyl or aryl.

2. The composition of claim 1, wherein the aliphatic polycarbonate is expressed by Chemical formula 1 below: 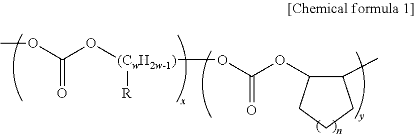
Where, w is an integer of 2 to 10, x is an integer of 5 to 100, y is an integer of 0 to 100, n is an integer of 1 to 3, and R is hydrogen, (C1-C4) alkyl or —CH2-O—R′, wherein R′ is (C1˜C8)alkyl.

3. The composition of claim 1, wherein the composition for paper coating contains 1 to 70 wt % of polylactic acid based on the total amount of the composition.

4. A method for coating a paper, by extrusion-coating the composition for paper coating of claim 1 at 150 to 230° C. on the paper to manufacture a coated paper.

5. A method for coating a paper, by extrusion-coating the composition for paper coating of claim 2 at 150 to 230° C. on the paper to manufacture a coated paper.

6. A method for coating a paper, by extrusion-coating the composition for paper coating of claim 3 at 150 to 230° C. on the paper to manufacture a coated paper.

7. The method of claim 4, wherein the manufactured coated paper contains a residual coating composition in a content of 2 wt % or less based on the total amount of the composition before thermal treatment, when the thermal treatment is performed at 220° C. for 60 minutes under the inert gas ambience.

8. The method of claim 5, wherein the manufactured coated paper contains a residual coating composition in a content of 2 wt % or less based on the total amount of the composition before thermal treatment, when the thermal treatment is performed at 220° C. for 60 minutes under the inert gas ambience.

9. The method of claim 6, wherein the manufactured coated paper contains a residual coating composition in a content of 2 wt % or less based on the total amount of the composition before thermal treatment, when the thermal treatment is performed at 220° C. for 60 minutes under the inert gas ambience.
